(19) United States
(12) Patent Application Publication
(10) Pub. No.: US 2025/0299460 A1
(43) Pub. Date: Sep. 25, 2025

(54) DOMAIN-ADAPTIVE OBJECT DETECTION METHOD AND APPARATUS

(71) Applicants: HYUNDAI MOTOR COMPANY, Seoul (KR); Kia Corporation, Seoul (KR); AJOU UNIVERSITY INDUSTRY-ACADEMIC COOPERATION FOUNDATION, Suwon-si (KR)

(72) Inventors: Jiwon KIM, Hwaseong-si (KR); Kyunghwan CHO, Hwaseong-si (KR); Moonsub JIN, Hwaseong-si (KR); Keonho LEE, Hwaseong-si (KR); Wonjun HWANG, Seoul (KR); Taehoon KIM, Suwon-si (KR); Dinh Phat DO, Suwon-si (KR)

(21) Appl. No.: 19/088,191

(22) Filed: Mar. 24, 2025

(30) Foreign Application Priority Data
Mar. 22, 2024 (KR) 10-2024-0039487
Feb. 28, 2025 (KR) 10-2025-0026776

(51) Int. Cl. G06V 10/25; H04N 23/23

(52) U.S. Cl. CPC G06V 10/25; H04N 23/23; G06V 2201/07

(57) ABSTRACT

A domain-adaptive object detection method performed by a computing device, which includes a processor and a memory, may include: acquiring, by the processor, an RGB (red, green, blue) teacher model, a thermal teacher model, and a student model; determining, by the processor, a training iteration of the thermal teacher model as a first value; determining, by the processor, a training iteration of the RGB teacher model as a second value; performing, by the processor, thermal domain training on the thermal teacher model and the student model for a number of iterations corresponding to the first value; and performing, by the processor, RGB domain training on the RGB teacher model and the student model for a number of iterations corresponding to the second value.

### CROSS-REFERENCE TO RELATED APPLICATION

This application claims priority to and the benefit of Korean Patent Application No. 10-2024-0039487 filed in the Korean Intellectual Property Office on Mar. 22, 2024, Korean Patent Application No. 10-2025-0026776 filed in the Korean Intellectual Property Office on Feb. 28, 2025 and the entire contents of which are incorporated herein by reference.

### TECHNICAL FIELD

The present disclosure relates to a domain-adaptive object detection method and apparatus.

### BACKGROUND

Domain adaptation for object detection typically involves transferring knowledge between visual domains. However, adaptation from a visual domain to a thermal domain is relatively unexplored due to the substantial gap between them. Conventional domain adaptation methods focus on minimizing the discrepancy between a labeled source domain and an unlabeled target domain. However, when the domain gap is as large as that between RGB (Red, Green, Blue) and thermal domains, these methods prove less effective. The distinct sensor characteristics and data representations further hinder effective learning through conventional techniques alone.

### SUMMARY

The present disclosure is directed to a domain-adaptive object detection method and apparatus capable of effectively performing domain adaptation in environments where the domain gap is large, such as between RGB and thermal domains.

According to one aspect of the subject matter described in this application, a domain-adaptive object detection method may be performed by a computing device including a processor and a memory. The domain-adaptive object detection method may include acquiring, by the processor, an RGB (red, green, blue) teacher model, a thermal teacher model, and a student model; determining, by the processor, a training iteration of the thermal teacher model as a first value; determining, by the processor, a training iteration of the RGB teacher model as a second value; performing, by the processor, thermal domain training on the thermal teacher model and the student model for a number of iterations corresponding to the first value; and performing, by the processor, RGB domain training on the RGB teacher model and the student model for a number of iterations corresponding to the second value.

In some implementations, performing the thermal domain training may include calculating, by the processor, a first loss related to the thermal domain training using thermal domain training data, updating, by the processor, weights of the student model based on the first loss, and updating, by the processor, weights of the thermal teacher model using the weights of the student model and an exponential moving average (EMA).

In some examples, the first loss related to the thermal domain training may be determined according to the following Equation 1:

$${L}_{thr} = {L}_{un} ( {f}^{S} ( {I}_{thr} ) , {f}_{thr}^{T} ( {I}_{thr} ) ) + {L}_{un} ( {f}^{S} ( {I}_{thr} ) , {f}_{rgb}^{T} ( {I}_{thr} ) ) , \qquad ( Equation 1 )$$

where Lₜₕᵣ may be the first loss, Lᵤₙ may be an unsupervised learning loss, f^{S} may be the student model, fₜₕᵣ^{T} may be the teacher model for the thermal domain, f_{rgb}^{T} may be the teacher model for the RGB domain, and Iₜₕᵣ is the thermal domain training data.

In some implementations, performing the RGB domain training may include calculating, by the processor, a second loss related to the RGB domain training using RGB domain training data, updating, by the processor, weights of the student model based on the second loss, and updating, by the processor, weights of the RGB teacher model using the weights of the student model and an exponential moving average (EMA).

In some examples, the second loss related to the RGB domain training may be determined according to the following Equation 2:

$${L}_{rgb \_ sup} = {L}_{sup} ( {f}^{S} ( {I}_{rgb} ) , Y ) , \qquad ( Equation 2 )$$

where L_{rgb_sup} is the second loss, Lₛᵤₚ is a supervised learning loss, f^{S} is the student model, I_{rgb} is the RGB domain training data, and Y is a ground truth (GT) label.

In some examples, the second loss related to the RGB domain training may be determined according to the following Equation 3:

$${L}_{rgb} = {L}_{rgb \_ sup} + λ {L}_{rgb \_ unsup} , \qquad ( Equation 3 )$$

where L_{rgb} is the second loss, L_{rgb_sup} is a supervised learning loss of the RGB domain, L_{rgb_unsup} is an unsupervised learning loss of the RGB domain, and λ is a hyperparameter for controlling the degree of pseudo labels used during the RGB domain training.

In some examples, L_{rgb_unsup} may be determined according to the following Equation 4:

$${L}_{rgb \_ unsup} = {L}_{un} ( {f}^{S} ( {I}_{rgb} ) , {f}_{rgb}^{T} ( {I}_{rgb} ) ) + {L}_{un} ( {f}^{S} ( {I}_{rgb} ) , {f}_{thr}^{T} ( {I}_{rgb} ) ) , \qquad ( Equation 4 )$$

where Lᵤₙ is an unsupervised learning loss, f^{S} is the student model, fₜₕᵣ^{T} is a teacher model for the thermal domain, f_{rgb}^{T} is a teacher model for the RGB domain, and I_{rgb} is the RGB domain training data.

In some implementations, the method may further include changing, by the processor, the training iteration of the thermal teacher model to a third value after performing the RGB domain training for a number of iterations corresponding to the second value, where the third value is greater than the first value, and performing, by the processor, the thermal domain training on the thermal teacher model and the student model for a number of iterations corresponding to the third value.

In some examples, the method may further include changing, by the processor, the training iteration of the RGB teacher model to a fourth value after performing the RGB domain training for a number of iterations corresponding to the second value, where the fourth value is less than the second value, and performing, by the processor, the RGB domain training on the RGB teacher model and the student model for a number of iterations corresponding to the fourth value.

In some examples, the third value and the fourth value may be determined such that a sum of the third value and the fourth value is equal to a sum of the first value and the second value. In some implementations, the method may further include performing, by the processor, pre-training of the student model on a RGB domain.

In some implementations, the method may further include receiving, by the processor, RGB image data or thermal image data, and inputting, by the processor, the RGB image data or the thermal image data into the student model to generate an object detection result.

According to another aspect of the subject matter described in this application, a domain-adaptive object detection method may be performed by a computing device including a processor and a memory. The domain-adaptive object detection method may include acquiring, by the processor, a student model trained alternately through (i) thermal domain training using a thermal teacher model and (ii) RGB domain training using an RGB teacher model, receiving, by the processor, RGB image data or thermal image data; and inputting, by the processor, the RGB image data or the thermal image data into the student model to generate an object detection result.

In some implementations, weights of the student model may be updated based on a first loss calculated using thermal domain training data and a second loss calculated using RGB domain training data. In some examples, weights of the thermal teacher model may be updated using the weights of the student model and an exponential moving average (EMA) after the weights of the student model have been updated based on the first loss.

In some examples, weights of the RGB teacher model may be updated using the weights of the student model and an exponential moving average (EMA) after the weights of the student model have been updated based on the second loss.

According to another aspect of the subject matter described in this application, a domain-adaptive object detection apparatus may include at least one processor and at least one memory, where the at least one memory stores instructions that, when executed by the at least one processor, cause the at least one processor to perform operations. The operations may include acquiring a student model trained alternately through (i) thermal domain training using a thermal teacher model and (ii) RGB (red, green, blue) domain training using an RGB teacher model, receiving RGB image data or thermal image data, and inputting the RGB image data or the thermal image data into the student model to generate an object detection result.

In some implementations, weights of the student model may be updated based on a first loss calculated using thermal domain training data and a second loss calculated using RGB domain training data. In some examples, weights of the thermal teacher model may be updated using the weights of the student model and an exponential moving average (EMA) after the weights of the student model have been updated based on the first loss.

In some examples, weights of the RGB teacher model may be updated using the weights of the student model and an exponential moving average (EMA) after the weights of the student model have been updated based on the second loss.

### BRIEF DESCRIPTION OF THE DRAWINGS

FIG. 1 is a diagram illustrating an example of a domain-adaptive object detection apparatus.

FIG. 2 is a diagram illustrating an example of a domain-adaptive object detection apparatus.

FIGS. 3 to 4 are diagrams illustrating examples of a domain-adaptive object detection apparatus.

FIG. 5 is a diagram illustrating an example of a domain-adaptive object detection method.

FIG. 6 is a diagram illustrating an example of a domain-adaptive object detection method.

FIG. 7 is a diagram illustrating an example of a domain-adaptive object detection method and apparatus.

FIG. 8 is a diagram illustrating an example of a computing device.

### DETAILED DESCRIPTION

The embodiments of the present invention will now be described in detail with reference to the accompanying drawings so that those skilled in the art can easily implement the present invention. However, the present invention may be implemented in various different forms and is not limited to the embodiments described herein. Additionally, parts irrelevant to the explanation have been omitted from the drawings to clearly describe the present invention, and similar reference numerals are assigned to similar components throughout the specification.

Throughout the specification and claims, when a component is described as “including” another component, it means that other components may also be included unless explicitly stated otherwise, rather than excluding other components. The ordinal terms such as “first,” “second,” and the like may be used to describe various components but do not limit the components by these terms. These terms are used solely to distinguish one component from another.

The terms such as “ . . . unit,” “ . . . device,” and “module” described in the specification may refer to units capable of processing at least one function or operation described in the present specification. These may be implemented as hardware, circuits, software, or a combination of hardware, circuits, and software. Furthermore, at least some of the components or functions of the domain-adaptive object detection method and apparatus according to one or more embodiments may be implemented as programs or software, and such programs or software may be stored in a computer-readable recording medium or storage medium.

The mathematical expressions (for example, equations) presented in this specification may be represented in data form and stored in a recording medium or storage medium, or in a remote computing device or cloud environment. Here, the recording medium or storage medium, remote computing device, or cloud environment may be implemented to be accessible by a computing device that performs the domain-adaptive object detection apparatus or domain-adaptive object detection method according to one or more embodiments. The computing device that performs the domain-adaptive object detection apparatus or domain-adaptive object detection method according to one or more embodiments may read the data related to the mathematical expressions from the recording medium or storage medium and load it into memory, or receive the data related to the mathematical expressions from a remote computing device or cloud environment via a network and load it into memory in order to perform a series of operations associated with the mathematical expressions.

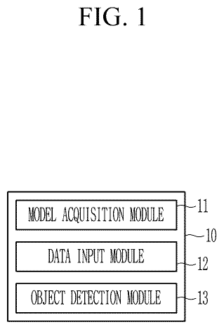

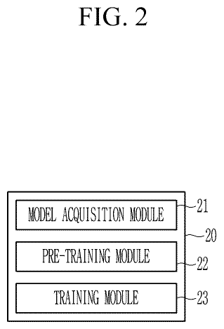

FIG. 1 is a diagram illustrating an example of a domain-adaptive object detection apparatus, and FIG. 2 is a diagram illustrating an example of a domain-adaptive object detection apparatus.

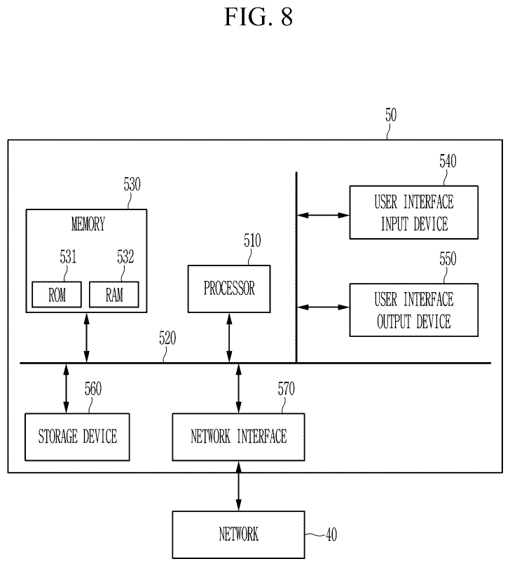

Referring to FIGS. 1 and 2, a domain-adaptive object detection apparatus 10 and 20 can execute program code or instructions loaded into one or more memories via one or more processors. For example, each of the domain-adaptive object detection apparatuses 10 and 20 may be implemented as a computing device 50 as with respect to FIG. 8.

In some implementations, the one or more processors may refer to the processor 510 of the computing device 50, and the one or more memories may refer to the memory 530 of the computing device 50. The program code or instructions may be executed by the one or more processors to perform domain-adaptive object detection. For example, the term “module” can logically distinguish functions performed by the program code or instructions.

As depicted in FIGS. 1 and 2, the domain-adaptive object detection apparatus 10 and the domain-adaptive object detection apparatus 20 are illustrated separately. Specifically, the domain-adaptive object detection apparatus 10 depicted in FIG. 1 may be configured from the perspective of an inference process that performs object detection, whereas the domain-adaptive object detection apparatus 20 depicted in FIG. 2 may be configured from the perspective of a training process for the model used in object detection. However, such a distinction is purely logical and does not necessarily mean that the domain-adaptive object detection apparatus 10 and the domain-adaptive object detection apparatus 20 are implemented as separate hardware or separate software.

For example, the domain-adaptive object detection apparatus 10 and the domain-adaptive object detection apparatus 20 may be implemented using different hardware or software. In some implementations, the domain-adaptive object detection apparatus 10 and the domain-adaptive object detection apparatus 20 may be implemented using the same hardware or software. In some implementations, at least a portion of the domain-adaptive object detection apparatus 10 and at least a portion of the domain-adaptive object detection apparatus 20 may be implemented using the same hardware or software, while at least another portion of the domain-adaptive object detection apparatus 10 and at least another portion of the domain-adaptive object detection apparatus 20 may be implemented using different hardware or software.

Referring to FIG. 1, the domain-adaptive object detection apparatus 10 may include a model acquisition module 11, a data input module 12, and an object detection module 13. Referring to FIG. 2, the domain-adaptive object detection apparatus 20 may include a model acquisition module 21, a pre-training module 22, and a training module 23.

In some implementations, the domain-adaptive object detection apparatus 10 and the domain-adaptive object detection apparatus 20 can share at least a portion of their components. Therefore, the model acquisition module 11 and the model acquisition module 21 should not necessarily be interpreted as distinct entities. Consequently, the explanation of the model acquisition module 11 can also apply to the model acquisition module 21, provided no contradictions arise.

The model acquisition module 11 can acquire an RGB teacher model, a thermal teacher model, and a student model. The RGB teacher model may refer to a model trained in the RGB domain (i.e., the visible light domain) to detect objects in RGB images, and the thermal teacher model may refer to a model trained in the thermal domain to detect objects in thermal images. The student model may refer to a model trained to perform object detection in both the RGB and thermal domains based on knowledge learned from the RGB teacher model and the thermal teacher model.

For example, the model acquisition module 11 may acquire a student model that has been trained alternately through (i) thermal domain training using the thermal teacher model and (ii) RGB domain training using the RGB teacher model. A more detailed process regarding the training will be described later with respect to the domain-adaptive object detection apparatus 20.

The data input module 12 may receive RGB image data or thermal image data. For example, the RGB image data may be acquired using a standard visible-light camera and may be provided in a multi-channel format (e.g., R, G, B) that includes color information. In some implementations, the thermal image data may be acquired using an infrared sensor and may be provided in a single-channel grayscale or color map image format that reflects the temperature differences of target objects. For example, the RGB image data and the thermal image data may be obtained from visible-light cameras and infrared sensors implemented in autonomous vehicles, robots, and surveillance systems.

The object detection module 13 may input the RGB image data or thermal image data received through the data input module 12 into the student model to generate an object detection result. Since the student model is trained through domain-adaptive learning to process both RGB image data and thermal image data, the student model may detect objects regardless of the domain of the input image and output detection results, such as a bounding box or a class label.

Referring to FIG. 2, the model acquisition module 21 may acquire an RGB teacher model, a thermal teacher model, and a student model.

The pre-training module 22 may train the student model before performing domain adaptation through zigzag learning, which will be described later with respect to the training module 23. This initial training process may refer to a burn-in stage, and may be performed to ensure the basic object detection capability of the student model, thereby enabling effective training for the subsequent domain adaptation.

In some implementations, the pre-training module 22 may perform pre-training of the student model on the RGB domain. For example, the pre-training module 22 may train the student model using labeled data from the RGB domain. Specifically, the training of the student model may be conducted using a supervised learning approach, allowing the object detection performance to be improved beyond a predetermined level using labeled data from the RGB domain.

The training module 23 may perform domain adaptation training on the student model that has been pre-trained by the pre-training module 22. The training module 23 may alternately perform thermal domain training using the thermal teacher model and RGB domain training using the RGB teacher model.

For example, the training module 23 may determine the training iteration of the thermal teacher model as a first value. In addition, the training module 23 may determine the training iteration of the RGB teacher model as a second value. Based on the training iterations determined as the first value and the second value, the training module 23 may alternately perform thermal domain training using the thermal teacher model and RGB domain training using the RGB teacher model.

For example, the training module 23 may perform thermal domain training on the thermal teacher model and the student model for a number of iterations corresponding to the first value and perform RGB domain training on the RGB teacher model and the student model for a number of iterations corresponding to the second value.

Such training may be performed using a harmonious teacher (HT) approach. This approach can enable the student model to apply the knowledge of both teacher models to an image from a single domain, while only the teacher model corresponding to the domain undergoing HT training is updated. For example, the student model applies the knowledge of both the thermal teacher model and the RGB teacher model when training with thermal domain training data in the form of thermal images. However, during the training process based on thermal domain training data, only the thermal teacher model is updated, while the RGB teacher model may not be updated. Similarly, the student model can apply the knowledge of both the thermal teacher model and the RGB teacher model when training with RGB domain training data in the form of RGB images. However, during the training process based on RGB domain training data, only the RGB teacher model is updated, while the thermal teacher model may not be updated. By adopting this training approach, effective domain adaptation can be achieved in environments where the domain gap between the RGB domain and the thermal domain is large.

In some implementations, the training module 23 may calculate a first loss related to thermal domain training using thermal domain training data to perform thermal domain training using the thermal teacher model. The training module 23 may update the weights of the student model based on the first loss.

In some implementations, the training module 23 may update the weights of the thermal teacher model using the weights of the student model and an exponential moving average (EMA). For example, the weights of the RGB teacher model remain unchanged and are not updated. This can block unnecessary modifications to the RGB teacher model during the thermal domain training process and improve the learning effectiveness of thermal domain training.

In some implementations, EMA gradually reflects the weights of the student model in the teacher model during the training process, allowing the teacher model to be trained in a stable manner. For example, instead of directly applying the weights of the student model to the thermal teacher model, the training module 23 can apply an exponential moving average to gradually update the teacher model, thereby improving training stability.

In some implementations, the first loss related to thermal domain training may be determined according to the following Equation 1.

$${L}_{thr} = {L}_{un} ( {f}^{S} ( {I}_{thr} ) , {f}_{thr}^{T} ( {I}_{thr} ) ) + {L}_{un} ( {f}^{S} ( {I}_{thr} ) , {f}_{rgb}^{T} ( {I}_{thr} ) ) \qquad ( Equation 1 )$$

Here, Lₜₕᵣ may refer to the first loss, Lᵤₙ may refer to an unsupervised learning loss, f^{S} may refer to the student model, fₜₕᵣ^{T} may refer to the teacher model for the thermal domain, f_{rgb}^{T} may refer to the teacher model for the RGB domain, and Iₜₕᵣ may refer to the thermal domain training data.

In some implementations, the training module 23 may calculate a second loss related to RGB domain training using RGB domain training data to perform RGB domain training using the RGB teacher model. The training module 23 may update the weights of the RGB teacher model using EMA of the student model. For example, the weights of the thermal teacher model remain unchanged and are not updated. This can block unnecessary modifications to the thermal teacher model during the RGB domain training process and improve the learning effectiveness of RGB domain training.

In some implementations, EMA gradually reflects the weights of the student model in the teacher model during the training process, allowing the teacher model to be trained in a stable manner. For example, instead of directly applying the weights of the student model to the RGB teacher model, the training module 23 can apply an exponential moving average to gradually update the teacher model, thereby improving training stability.

In some implementations, the second loss related to RGB domain training may be determined according to the following Equation 2.

$${L}_{rgb \_ sup} = {L}_{sup} ( {f}^{S} ( {I}_{rgb} ) , Y ) \qquad ( Equation 2 )$$

Here, L_{rgb_sup} may refer to the second loss, Lₛᵤₚ may refer to a supervised learning loss, f^{S} may refer to the student model, I_{rgb} may refer to the RGB domain training data, and Y may refer to a ground truth (GT) label.

For example, the weights of the student model may be updated based on the first loss calculated using thermal domain training data and the second loss calculated using RGB domain training data. In addition, the weights of the thermal teacher model may be updated using the weights of the student model and EMA after the weights of the student model have been updated based on the first loss. Similarly, the weights of the RGB teacher model may be updated using the weights of the student model and EMA after the weights of the student model have been updated based on the second loss.

In some implementations, domain adaptation utilizing zigzag learning can enable effective domain adaptation in environments where the domain gap between the RGB domain and the thermal domain is large. This can allow stable and accurate object detection in a new target domain.

In some implementations, the second loss related to RGB domain training may be determined according to the following Equation 3.

$${L}_{rgb} = {L}_{rgb \_ sup} + λ {L}_{rgb \_ unsup} \qquad ( Equation 3 )$$

Here, L_{rgb} may refer to the second loss, L_{rgb_sup} may refer to a supervised learning loss of the RGB domain, L_{rgb_unsup} may refer to an unsupervised learning loss of the RGB domain, and A may refer to a hyperparameter for controlling the degree of pseudo labels used during the RGB domain training.

In some implementations, after initially starting training with GT labels, the pseudo labels generated by the thermal teacher model and the RGB teacher model can be gradually integrated into the training process along with the GT labels. This approach can achieve performance improvement.

In some implementations, L_{rgb_unsup} may be determined according to the following Equation 4.

$${L}_{rgb \_ unsup} = {L}_{un} ( {f}^{S} ( {I}_{rgb} ) , {f}_{rgb}^{T} ( {I}_{rgb} ) ) + {L}_{un} ( {f}^{S} ( {I}_{rgb} ) , {f}_{thr}^{T} ( {I}_{rgb} ) ) \qquad ( Equation 4 )$$

Here, Lᵤₙ may refer to an unsupervised learning loss, f^{S} may refer to the student model, fₜₕᵣ^{T} may refer to a teacher model for the thermal domain, f_{rgb}^{T} may refer to a teacher model for the RGB domain, and I_{rgb} may refer to the RGB domain training data.

In some implementations, the training module 23 may adjust the training amount so that the amount of thermal domain training gradually increases while the amount of RGB domain training decreases. For example, after performing RGB domain training for a number of iterations corresponding to the second value, the training module 23 may change the number of training iterations of the thermal teacher model to a third value greater than the first value. The training module 23 may, after changing the number of training iterations of the thermal teacher model to the third value, perform thermal domain training on the thermal teacher model and the student model for a number of iterations corresponding to the third value.

For example, if the second value is Z_{rgb}, after performing RGB domain training for a number of iterations of Z_{rgb}, the training module 23 may change the number of iterations of the thermal teacher model to a third value (Zₜₕᵣ+β), where β is a natural number and Zₜₕᵣ is the first value. The training module 23 may then perform thermal domain training on the thermal teacher model and the student model for a number of iterations of the third value (Zₜₕᵣ+β).

Additionally, the training module 23 may change the number of training iterations of the RGB teacher model to a fourth value less than the second value after performing RGB domain training for the number of iterations corresponding to the second value. The training module 23 may then perform RGB domain training on the RGB teacher model and the student model for a number of iterations corresponding to the fourth value.

For example, after performing RGB domain training for a number of iterations of Z_{rgb}, the training module 23 may change the number of training iterations of the RGB teacher model to a fourth value (Z_{rgb}−β), where β is a natural number and Z_{rgb} is the second value. The training module 23 may then perform RGB domain training on the RGB teacher model and the student model for a number of iterations of the fourth value (Z_{rgb}−β).

In some implementations, the third value and the fourth value may be determined such that the sum of the third value and the fourth value is equal to the sum of the first value and the second value. For example, the sum of the third value (Zₜₕᵣ+β) and the fourth value (Z_{rgb}−β) may be determined to be equal to the sum of the first value Zₜₕᵣ and the second value Z_{rgb}.

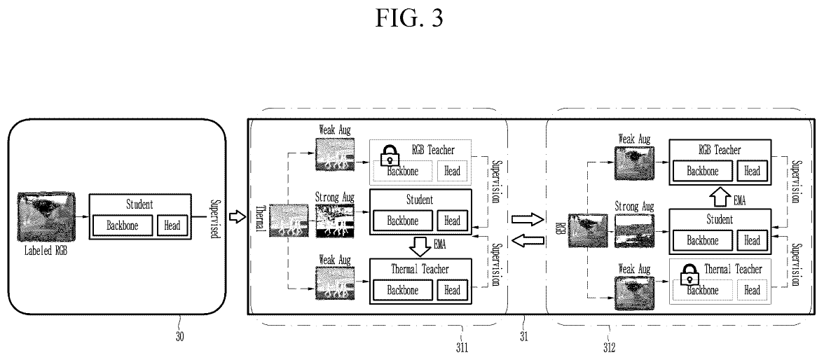

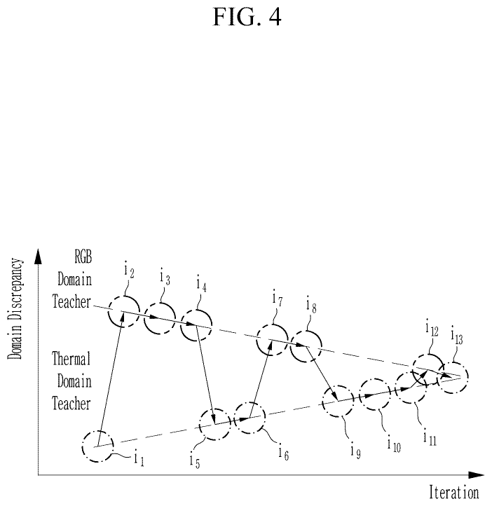

FIGS. 3 to 4 are diagrams illustrating examples of a domain-adaptive object detection apparatus.

Referring to FIGS. 3 and 4, the training of the domain-adaptive object detection apparatus may be performed through a burn-in stage 30 and a zigzag learning stage 31. In the burn-in stage 30, training of the student model may be performed using labeled RGB domain training data.

In the subsequent zigzag learning stage 31, thermal domain training 311 and RGB domain training 312 may be alternately performed. When thermal domain training 311 is performed, weakly or minimally augmented thermal domain training data may be input to the thermal teacher model and the RGB teacher model, while strongly or extensively augmented thermal domain training data may be input to the student model. In this case, supervised learning may be performed on the student model based on the thermal teacher model and the RGB teacher model. However, the weights of the thermal teacher model may be updated using the weights of the student model and EMA, while the weights of the RGB teacher model may remain unchanged and not updated.

In some implementations, when RGB domain training 312 is performed, weakly or minimally augmented RGB domain training data may be input to the thermal teacher model and the RGB teacher model, while strongly or extensively augmented RGB domain training data may be input to the student model. In this case, supervised learning may be performed on the student model based on the thermal teacher model and the RGB teacher model. However, the weights of the RGB teacher model may be updated using the weights of the student model and EMA, while the weights of the thermal teacher model may remain unchanged and not updated.

In the zigzag learning stage 31, training may be performed in a manner that gradually increases the amount of thermal domain training while decreasing the amount of RGB domain training. For example, referring to FIG. 4, following the burn-in stage 30, thermal domain training 311 may be performed once. In this case, the iteration of thermal domain training 311 may include iteration i₁. Next, RGB domain training 312 may be performed three times. The iterations of RGB domain training 312 may include iterations i₂, i₃, and i₄. Then, thermal domain training 311 may be performed twice, with iterations i₅ and i₆. Subsequently, RGB domain training 312 may be performed twice, with iterations i₇ and i₈. Next, thermal domain training 311 may be performed three times, with iterations i₉, i₁₀, and i₁₁. Then, RGB domain training 312 may be performed once, with iteration i₁₂. Finally, thermal domain training 311 may be performed once, with iteration i₁₃.

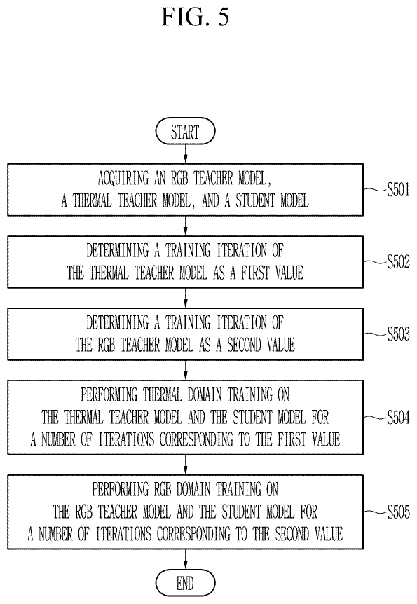

FIG. 5 is a diagram illustrating an example of a domain-adaptive object detection method.

Referring to FIG. 5, the domain-adaptive object detection method may include a step S501 of acquiring an RGB teacher model, a thermal teacher model, and a student model, a step S502 of determining a training iteration of the thermal teacher model as a first value, a step S503 of determining a training iteration of the RGB teacher model as a second value, a step S504 of performing thermal domain training on the thermal teacher model and the student model for a number of iterations corresponding to the first value, and a step S505 of performing RGB domain training on the RGB teacher model and the student model for a number of iterations corresponding to the second value.

Since more detail regarding the method may be found in the descriptions in this specification, redundant content is omitted here.

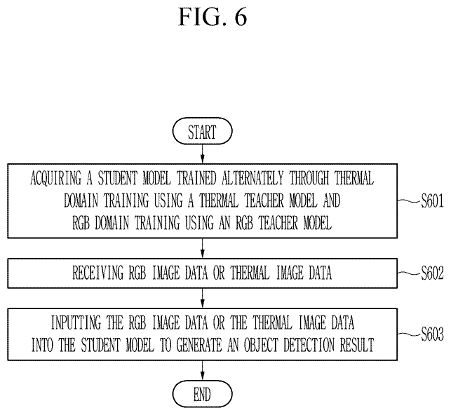

FIG. 6 is a diagram illustrating an example of a domain-adaptive object detection method.

Referring to FIG. 6, the domain-adaptive object detection method may include a step S601 of acquiring a student model trained alternately through thermal domain training using a thermal teacher model and RGB domain training using an RGB teacher model, a step S602 of receiving RGB image data or thermal image data, and a step S603 of inputting the RGB image data or the thermal image data into the student model to generate an object detection result.

Since more detail regarding the method may be found in the descriptions in this specification, redundant content is omitted here.

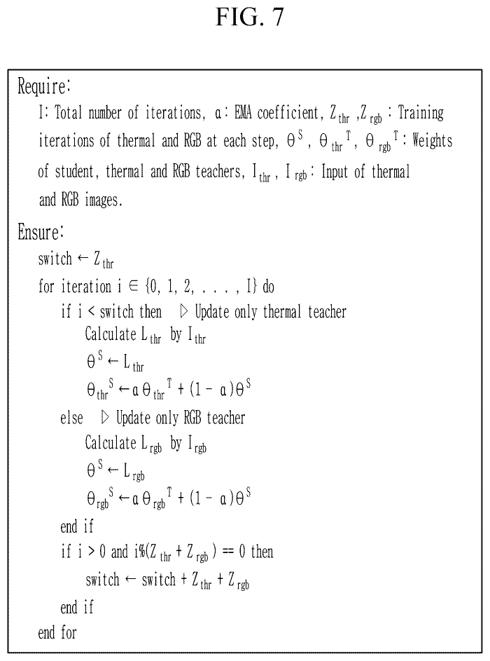

FIG. 7 is a diagram illustrating an implementation example of a domain-adaptive object detection method and apparatus.

Referring to FIG. 7, an implementation example of the domain-adaptive object detection method and apparatus may be represented in pseudo-code, where the transition between thermal domain training and RGB domain training in the zigzag learning stage may be implemented using a variable called “switch.”

In the illustrated pseudo-code, “I” may refer to the total number of training iterations, “α” may refer to the weighting coefficient of EMA, “Zₜₕᵣ” may refer to the number of iterations for thermal domain training, “Z_{rgb}” may refer to the number of iterations for RGB domain training, “θ^{S}” may refer to the weights of the student model, “θₜₕᵣ^{T}” may refer to the weights of the thermal teacher model, “θ_{rgb}^{T}” may refer to the weights of the RGB teacher model, “Iₜₕᵣ” may refer to the thermal domain training data (e.g., thermal images), and “I_{rgb}” may refer to the RGB domain training data (e.g., RGB images).

The variable switch may be initially assigned Zₜₕᵣ, so that thermal domain training is performed first. Afterward, training iterations may be executed “I” times, and the training domain may be determined at each iteration. If i is less than switch, the first loss Lₜₕᵣ may be calculated using Iₜₕᵣ, and θ^{S} may be updated based on Lₜₕᵣ. Then, θₜₕᵣ^{T} may be updated using EMA with α as the weighting coefficient. In some implementations, if i is not less than switch, the second loss L_{rgb} may be calculated using I_{rgb}, and θ^{S} may be updated based on L_{rgb}. Then, θ_{rgb}^{T} may be updated using EMA with α as the weighting coefficient.

Afterward, the value of switch may be adjusted. For example, if the conditions “i>0” and “i % (Zₜₕᵣ+Z_{rgb})==0” are satisfied, the value of switch may be updated by adding Zₜₕᵣ+Z_{rgb} to its current value.

FIG. 8 is a diagram illustrating an example of a computing device.

Referring to FIG. 8, the domain-adaptive object detection method and apparatus may be implemented using a computing device 50. Such a computing device 50 may be implemented as various types of electronic devices, servers, or similar devices, and its functionality may be realized through a combination of software and hardware.

The computing device 50 may include at least one of a processor 510, a memory 530, a user interface input device 540, a user interface output device 550, and a storage device 560, all of which communicate via a bus 520. The computing device 50 may also include a network interface 570 electrically connected to a network 40. The network interface 570 may transmit or receive signals to or from other entities through the network 40.

The processor 510 may be implemented as various types of computing units, such as a Microcontroller Unit (MCU), Application Processor (AP), Central Processing Unit (CPU), Graphics Processing Unit (GPU), Neural Processing Unit (NPU), or Quantum Processing Unit (QPU). The processor 510 may be a semiconductor device that executes instructions stored in the memory 530 or the storage device 560 and play a central role in the system. The program code and data stored in the memory 530 or the storage device 560 may instruct the processor 510 to perform specific tasks, enabling the overall operation of the system. Through this, the processor 510 may be configured to implement various functions and methods described earlier in relation to FIGS. 1 to 7.

The memory 530 and the storage device 560 may include various types of volatile or non-volatile storage media for storing and accessing system data. For example, the memory 530 may include read-only memory (ROM) 531 and random access memory (RAM) 532. In some implementations, the memory 530 may be embedded within the processor 510, in which case the data transfer speed between the memory 530 and the processor 510 may be significantly high. In some implementations, the memory 530 may be located externally to the processor 510, in which case the memory 530 may be connected to the processor 510 through various data buses or interfaces. Such connections may be established using well-known techniques, such as a Peripheral Component Interconnect Express (PCIe) interface or a memory controller for high-speed data transfer.

In some implementations, at least some components or functions of the domain-adaptive object detection method and apparatus may be implemented as a program or software executed on the computing device 50, and the program or software may be stored in a computer-readable recording medium or storage medium. Specifically, a computer-readable recording medium or storage medium may store a program that executes the steps included in the implementation of the domain-adaptive object detection method and apparatus on a computer, which includes a processor 510 that executes programs or instructions stored in the memory 530 or the storage device 560.

In some implementations, at least some components or functions of the domain-adaptive object detection method and apparatus may be implemented using hardware or circuitry of the computing device 50 or may be implemented as separate hardware or circuitry electrically connected to the computing device 50.

According to implementations of features described in this specification, robust object detection can be performed in the target domain using only the source domain data, even when labels are not available for the target domain data. In particular, through domain adaptation utilizing zigzag learning, effective domain adaptation can be achieved even in environments where the domain gap is large, such as between the RGB domain and the thermal domain. This enables stable and accurate object detection in a new target domain.

While the embodiments of the present invention have been described in detail above, the scope of the present invention is not limited thereto. Various modifications and improvements made by those skilled in the art using the fundamental concepts of the present invention as defined in the following claims also fall within the scope of the present invention.

What is claimed is:

1. A domain-adaptive object detection method performed by a computing device including a processor and a memory, the method comprising:
acquiring, by the processor, an RGB (red, green, blue) teacher model, a thermal teacher model, and a student model;
determining, by the processor, a training iteration of the thermal teacher model as a first value;
determining, by the processor, a training iteration of the RGB teacher model as a second value;
performing, by the processor, thermal domain training on the thermal teacher model and the student model for a number of iterations corresponding to the first value; and
performing, by the processor, RGB domain training on the RGB teacher model and the student model for a number of iterations corresponding to the second value.

2. The method of claim 1, wherein performing the thermal domain training comprises:
calculating, by the processor, a first loss related to the thermal domain training using thermal domain training data;
updating, by the processor, weights of the student model based on the first loss; and
updating, by the processor, weights of the thermal teacher model using the weights of the student model and an exponential moving average (EMA).

3. The method of claim 2, wherein the first loss related to the thermal domain training is determined according to the following Equation 1:
$${L}_{thr} = {L}_{un} ( {f}^{S} ( {I}_{thr} ) , {f}_{thr}^{T} ( {I}_{thr} ) ) + {L}_{un} ( {f}^{S} ( {I}_{thr} ) , {f}_{rgb}^{T} ( {I}_{thr} ) ) \qquad ( Equation 1 )$$
where Lₜₕᵣ is the first loss, Lᵤₙ is an unsupervised learning loss, f^{S} is the student model, fₜₕᵣ^{T} is the teacher model for the thermal domain, f_{rgb}^{T} is the teacher model for the RGB domain, and Iₜₕᵣ is the thermal domain training data.

4. The method of claim 1, wherein performing the RGB domain training comprises:
calculating, by the processor, a second loss related to the RGB domain training using RGB domain training data;
updating, by the processor, weights of the student model based on the second loss; and
updating, by the processor, weights of the RGB teacher model using the weights of the student model and an exponential moving average (EMA).

5. The method of claim 4, wherein the second loss related to the RGB domain training is determined according to the following Equation 2:
$${L}_{rgb \_ sup} = {L}_{sup} ( {f}^{S} ( {I}_{rgb} ) , Y ) \qquad ( Equation 2 )$$
where L_{rgb_sup} is the second loss, Lₛᵤₚ is a supervised learning loss, f^{S} is the student model, I_{rgb} is the RGB domain training data, and Y is a ground truth (GT) label.

6. The method of claim 4, wherein the second loss related to the RGB domain training is determined according to the following Equation 3:
$${L}_{rgb} = {L}_{rgb \_ sup} + λ {L}_{rgb \_ unsup} \qquad ( Equation 3 )$$
where L_{rgb} is the second loss, L_{rgb_sup} is a supervised learning loss of the RGB domain, L_{rgb_unsup} is an unsupervised learning loss of the RGB domain, and λ is a hyperparameter for controlling a degree of pseudo labels used during the RGB domain training.

7. The method of claim 6, wherein L_{rgb_unsup} is determined according to the following Equation 4:
$${L}_{rgb \_ unsup} = {L}_{un} ( {f}^{S} ( {I}_{rgb} ) , {f}_{rgb}^{T} ( {I}_{rgb} ) ) + {L}_{un} ( {f}^{S} ( {I}_{rgb} ) , {f}_{thr}^{T} ( {I}_{rgb} ) ) \qquad ( Equation 4 )$$
where Lᵤₙ is an unsupervised learning loss, f^{S} is the student model, fₜₕᵣ^{T} is a teacher model for the thermal domain, f_{rgb}^{T} is a teacher model for the RGB domain, and I_{rgb} is the RGB domain training data.

8. The method of claim 1, further comprising:
changing, by the processor, the training iteration of the thermal teacher model to a third value after performing the RGB domain training for a number of iterations corresponding to the second value, the third value being greater than the first value; and
performing, by the processor, the thermal domain training on the thermal teacher model and the student model for a number of iterations corresponding to the third value.

9. The method of claim 8, further comprising:
changing, by the processor, the training iteration of the RGB teacher model to a fourth value after performing the RGB domain training for a number of iterations corresponding to the second value, the fourth value being less than the second value; and
performing, by the processor, the RGB domain training on the RGB teacher model and the student model for a number of iterations corresponding to the fourth value.

10. The method of claim 9, wherein the third value and the fourth value are determined such that a sum of the third value and the fourth value is equal to a sum of the first value and the second value.

11. The method of claim 1, further comprising:
performing, by the processor, pre-training of the student model on a RGB domain.

12. The method of claim 1, further comprising:
receiving, by the processor, RGB image data or thermal image data; and
inputting, by the processor, the RGB image data or the thermal image data into the student model to generate an object detection result.

13. A domain-adaptive object detection method performed by a computing device including a processor and a memory, the method comprising:
acquiring, by the processor, a student model trained alternately through (i) thermal domain training using a thermal teacher model and (ii) RGB (red, green, blue) domain training using an RGB teacher model;
receiving, by the processor, RGB image data or thermal image data; and
inputting, by the processor, the RGB image data or the thermal image data into the student model to generate an object detection result.

14. The method of claim 13, wherein weights of the student model are updated based on a first loss calculated using thermal domain training data and a second loss calculated using RGB domain training data.

15. The method of claim 14, wherein weights of the thermal teacher model are updated using the weights of the student model and an exponential moving average (EMA) after the weights of the student model have been updated based on the first loss.

16. The method of claim 14, wherein weights of the RGB teacher model are updated using the weights of the student model and an exponential moving average (EMA) after the weights of the student model have been updated based on the second loss.

17. A domain-adaptive object detection apparatus comprising:
at least one processor; and
at least one memory,
wherein the at least one memory stores instructions that, when executed by the at least one processor, cause the at least one processor to perform operations comprising:
acquiring a student model trained alternately through (i) thermal domain training using a thermal teacher model and (ii) RGB (red, green, blue) domain training using an RGB teacher model;
receiving RGB image data or thermal image data; and
inputting the RGB image data or the thermal image data into the student model to generate an object detection result.

18. The apparatus of claim 17, wherein weights of the student model are updated based on a first loss calculated using thermal domain training data and a second loss calculated using RGB domain training data.

19. The apparatus of claim 18, wherein weights of the thermal teacher model are updated using the weights of the student model and an exponential moving average (EMA) after the weights of the student model have been updated based on the first loss.

20. The apparatus of claim 18, wherein weights of the RGB teacher model are updated using the weights of the student model and an exponential moving average (EMA) after the weights of the student model have been updated based on the second loss.
